(19) United States
(12) Patent Application Publication
(10) Pub. No.: US 2024/0421408 A1
(43) Pub. Date: Dec. 19, 2024

(54) Power Module Support Case and Method

(71) Applicant: Van Straten Enterprises, Inc., Chassell, MI (US)

(72) Inventor: George A. Van Straten, Chassell, MI (US)

(73) Assignee: Van Straten Enterprises, Inc., Chassell, MI (US)

(21) Appl. No.: 18/744,574

(22) Filed: Jun. 14, 2024

Related U.S. Application Data
(60) Provisional application No. 63/508,447, filed on Jun. 15, 2023.

(51) Int. Cl. H01M 50/249; H01M 10/615; H01M 10/6571; H01M 50/242

(52) U.S. Cl. CPC H01M 50/249; H01M 10/615; H01M 10/6571; H01M 50/242

(57) ABSTRACT

A power module support case is provided having an encasement with a cavity configured to house a power module, such as a battery, having a forward mounting bracket and a rearward mounting bracket of a quick coupling assembly for mating and de-mating the power module from both a service vehicle and a user vehicle. A heater and a shock mitigation device are also provided to enhance performance of the power module. A method of mating and de-mating such a power support module is also provided.

### CROSS REFERENCE TO RELATED APPLICATIONS

This patent application claims the benefit of U.S. Provisional Patent Application Ser. No. 63/508,447, filed Jun. 15, 2023, entitled “Interchangeable Power Module With Mechanical Quick Coupling Interface And Method”, the disclosures of which are incorporated herein by reference.

### TECHNICAL FIELD

This disclosure relates to electric vehicles and power modules for electric vehicles. More particularly, this disclosure pertains to interchangeable power units or modules that can be interchanged by mating and de-mating them from an electric or hybrid vehicle such as a car, truck, mine vehicle, autonomous vehicle or other partially or fully powered electric vehicle (EV).

### BACKGROUND OF THE DISCLOSURE

Techniques are known for mounting a source of power for an electric or partially electric vehicle. However, such electric power sources typically comprise batteries that are intricately affixed within the confines of a vehicle structure, such as within a floor pan or ends of a vehicle. For example, Lithium Ion batteries are often formed in many connected battery components that are somewhat flexible and are arranged so as to fit within the existing spaces found within the floor-pan of a vehicle envelope. As a result, such battery systems are not readily removed or replaced and are really never intended to be interchanged when a battery is fully discharged or low on power. Improvements are needed to make such switching out, or interchanging of a battery with a vehicle; for example, particularly when such batteries are used on industrial vehicles such as front-end loaders and fork lifts and used in diverse or rugged environments, such as mine vehicles being used in open pit mines and/or mine draws/runs (shafts). Further improvements are needed to increase access when mating, de-mating and interchanging batteries on such vehicles, as well as improving battery placement that maximizes load moment of a lifting vehicle.

### SUMMARY OF THE INVENTION

A vehicle power module is provided with mating and demating features that facilitate quick and easy mounting and demounting from a fully or partially electric vehicle. Furthermore, a method is also provided for mating and de-mating a power module. Even furthermore, power modules are provided that mount and demount from a vehicle frame using a plurality of spaced-apart mounting interfaces. In certain cases, vibration damping and/or heating devices are included with the power module to optimize module performance and reduce damage. Furthermore, such power modules can be carried on a vehicle in an orientation that provides a counterweight using mass of the power module in a placement relative to vehicle fulcrum wheels that increases vehicle moment to counteract load moment.

According to one aspect, a power module support case is provided having an encasement with a cavity configured to house a battery having a forward mounting bracket and a rearward mounting bracket of a quick coupling assembly for mating and de-mating the power module from both a service vehicle and a user vehicle, respectively.

According to another aspect, a power module support case is provided having a frame. The frame is configured to support a power module having a first mounting bracket and a second mounting bracket spaced from the first mounting bracket each configured to be mated and de-mated with a quick coupling assembly provided on both a service vehicle and a user vehicle.

According to yet another aspect, a method is provided for mating and de-mating a power module with a battery powered vehicle. The method includes: providing a vehicle having an interface for supporting a power module, a power module encasement for containing a source of power, a forward mating interface, and a rearward mating interface both complementary to the vehicle interface; engaging the rearward mating interface on the power module using another complementary interface on a loading vehicle; lifting the power module with the rearward mating interface; one of engaging and disengaging the forward mating interface on the vehicle interface while lifting the power support module and the battery with the rear mating interface using the another complementary mating interface on the loading vehicle; and releasing the rearward mating interface after one of engaging and disengaging the forward mating interface to mate the power module to the vehicle.

### BRIEF DESCRIPTION OF THE DRAWINGS

Exemplary embodiments of the various disclosures are described below with reference to the following accompanying drawings. The drawings may be considered to represent scale.

FIG. 1 is a perspective view from above and behind of a vehicle having a removable and swappable vehicle power module showing extra disassembled and assembled pairs of batteries and frames, or cages and further showing a cab top sliding solar panel array deployed into a use position.

FIG. 2 is a perspective view from above and behind of the vehicle in FIG. 1 having a removable and swappable vehicle power module showing extra disassembled and assembled pairs of batteries and frames, or cages and further showing a cab top sliding solar panel array stowed into a non-use position.

FIG. 3 is a perspective view from above and behind of a power module service vehicle, or truck supporting an array of swappable power modules each having an electric battery with a support frame, or cage that easily mates and demates with the vehicle of FIGS. 1-2 and FIG. 3.

FIG. 4 is a perspective view from above and in front showing a leading, or loading end of a power module with a forward bracket assembly that mates with a vehicle for which the module is being swapped out, or exchanged.

FIG. 5 is a perspective view from above and in front showing a trailing, or lifting end of a power module with a rearward bracket assembly that mates with a service vehicle that is used to remove and/or install the power module from a vehicle being powered by the power module.

FIG. 6 is a vertical front view of an electric vehicle power module mounting bracket assembly.

FIG. 7 is a rear vertical view of an electric vehicle (EV) having the mounting bracket assembly of FIG. 6 rigidly affixed to a frame of the vehicle to received and affix a power module thereto using a service vehicle (not shown) pickup up a power module on an opposed side of the power module.

FIG. 8 is an exploded, or disassembled perspective view from above and behind of an alternatively constructed power module over that shown in FIGS. 1-7 and having additional shock mitigating and heat generating capabilities.

FIG. 9 is an assembled view of the alternative power module of FIG. 8.

### DETAILED DESCRIPTION OF THE EMBODIMENTS

This disclosure is submitted in furtherance of the constitutional purposes of the U.S. Patent Laws “to promote the progress of science and useful arts” (Article 1, Section 8).

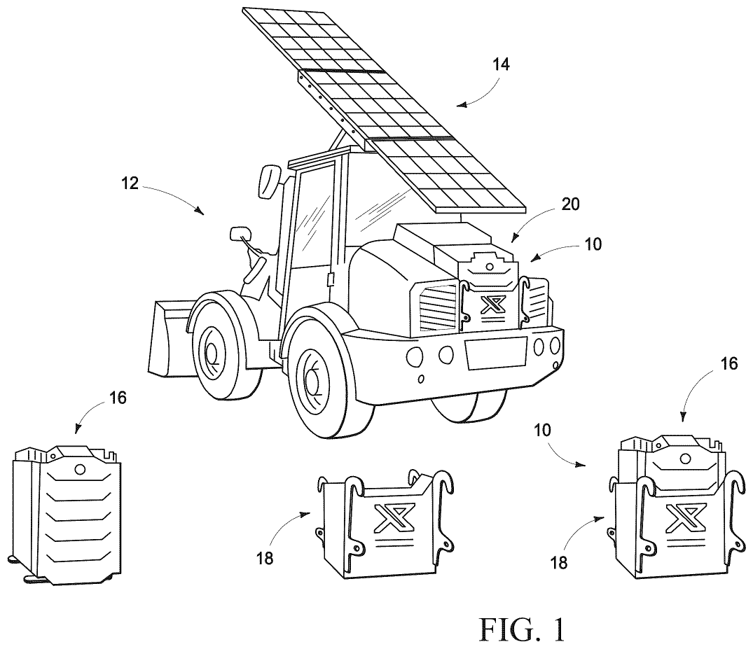

FIG. 1 is a perspective view from above and behind of a vehicle 12 having a removable and swappable vehicle power module 10 according to one aspect and showing extra disassembled and assembled pairs of batteries 16 and frames, or cages 20 and further showing a cab top sliding solar panel array 14 deployed into a use position.

As shown in FIG. 1, one power module 10 is installed and affixed within a receiving cavity, or bay 20 at a rear end of vehicle 12 where power module 10 is easily accessible to a service vehicle that has to attach to a rear portion of power module 10 in order to remove and/or attach power module 10 onto vehicle 12 within bay 20. Two other identical power modules are also shown in the foreground, one is disassembled to show an individual battery module 16 and a receiving frame or cage (or bucket) 18, and another is assembled with battery module 16 received within a recess of frame or cage 18.

As shown in FIG. 1, in one case power module 10 supports a Lithium-Ion (Li-ON) battery. In another case, lead acid or other comparable batteries can be supported. Further optionally, other forms of power supply can be provided including fuel cells, gas and diesel generators, and other suitable sources of generated, contained, and/or stored electric energy capable of being used by an electric vehicle (EV).

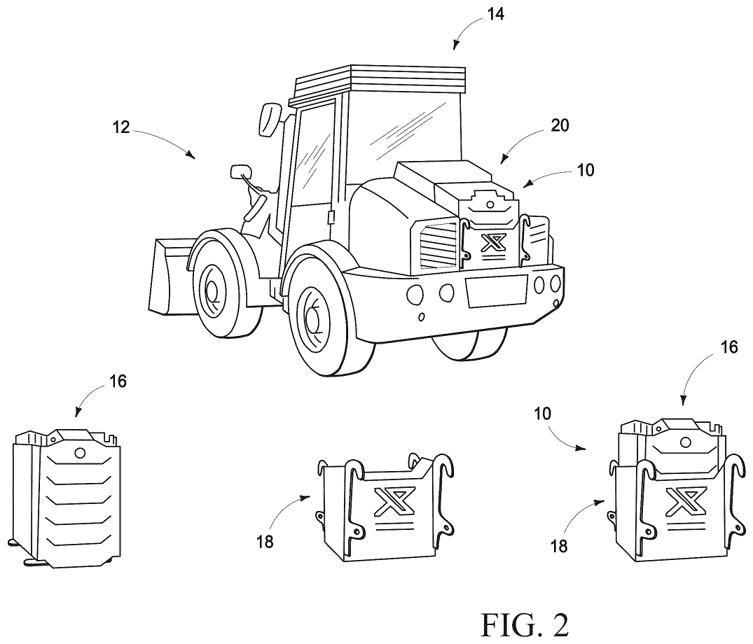

FIG. 2 is a perspective view from above and behind of the vehicle 12 in FIG. 1 having a removable and swappable vehicle power module 10 showing extra disassembled and assembled pairs of batteries 16 and frames, or cages 18 and further showing a cab top sliding solar panel array 14 stowed into a non-use position where top and bottom solar panels of a three panel array are retracted in tracks atop and below, respectively of a middle stationary solar panel and the array is dropped from a tilted position. The array 14 of solar panels when deployed (in FIG. 1) can be electrically coupled to trickle charge the battery of installed power module 10 in bay 20 of vehicle 12 especially when vehicle 12 is parked and in disuse such as in an open pit mine or other environment where solar energy is available.

As shown in FIGS. 1 and 2, power modules 16 are provided that mount and demount (or mate and de-mate) from a vehicle frame using a plurality of spaced-apart mounting interfaces. In certain cases, vibration damping and/or heating devices are included with the power module to optimize module performance and reduce damage. Furthermore, such power modules can be carried on a vehicle in an orientation that provides a counterweight using mass of the power module in a placement relative to vehicle fulcrum wheels that increases vehicle moment to counteract load moment. More particularly, provision of mounting brackets and vehicle interfaces (both user and service vehicles) such that a heavy power module (or battery) is placed oppose a working end, or loader end of a vehicle relative to a fulcrum wheel(s) provides a counterweight to loads carried by the vehicle on which the power module and support case are affixed. Provision of the power module and the mounting case as far back from the front (or fulcrum) wheels provides a further rearward center of gravity which enables larger loads to be carried by the work vehicle, such as a forklift, front end loader, crane, etc.

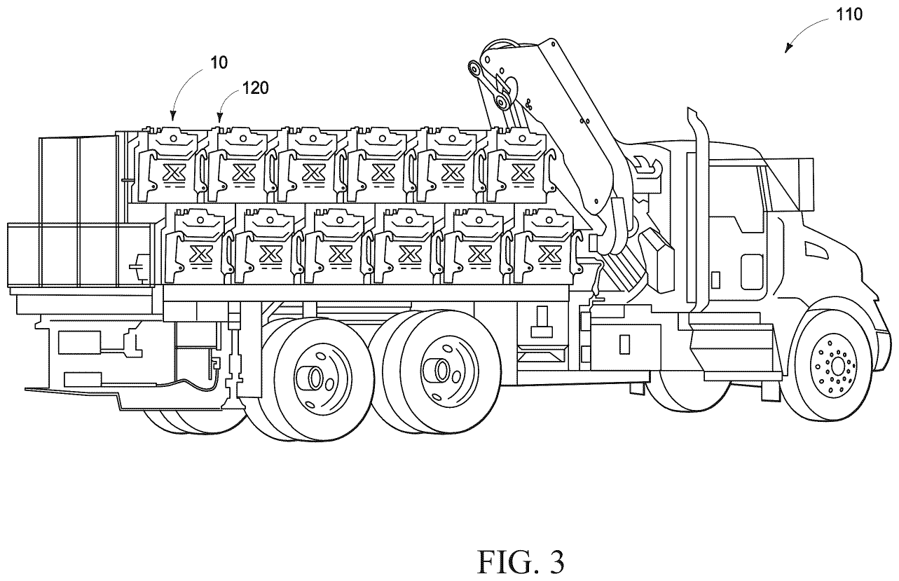

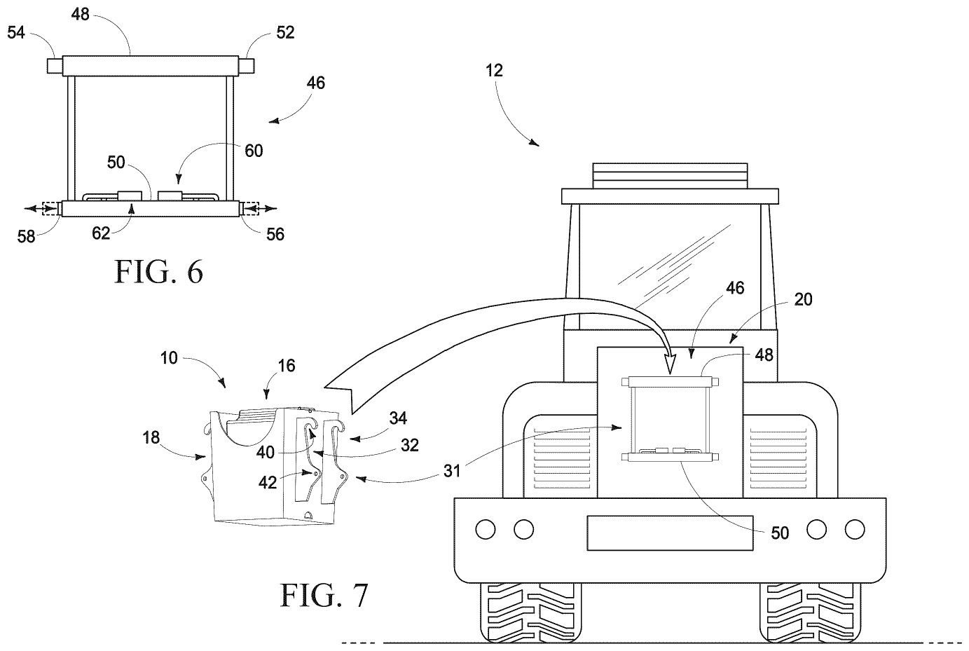

FIG. 3 is a perspective view from above and behind of a power module service vehicle, or truck 110 supporting an array of swappable power modules 10 within individual bays, or recesses 120 in frame components at the rear bed platform of vehicle 110. Each bay 120 houses or supports an individual power module having an electric battery with a support frame, or cage that easily mates and de-mates with the frame supports of vehicle 110, similar to mounting bracket assembly 46 of FIGS. 6 and 7. A hydraulic crane on vehicle 110 can also be used and configured to load and unload power modules 10 from bays 120 on vehicle 110.

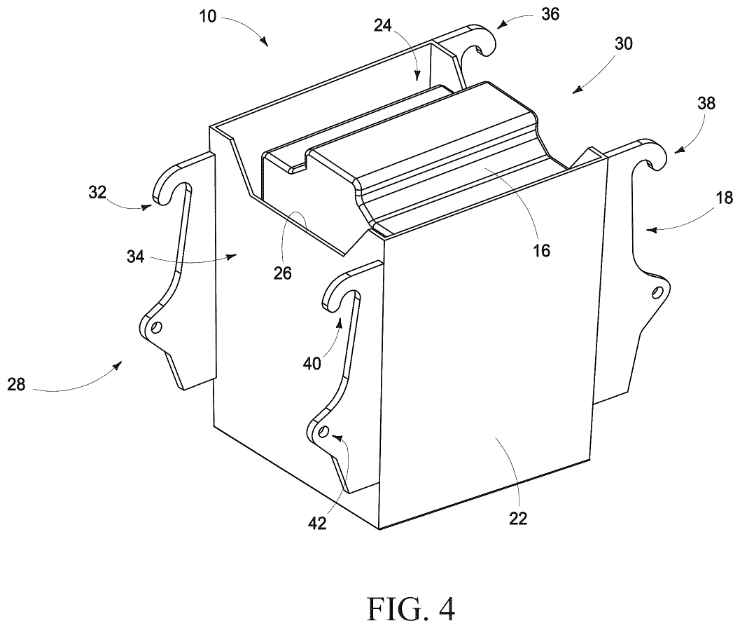

FIG. 4 is a perspective view from above and in front showing a leading, or loading end of a power module 10 with a forward bracket assembly 28 opposite a rear bracket assembly 30 having a pair of mounting brackets 32 and 34 that mate with an electrical vehicle for which the power module 10 is being swapped out, or exchanged to power such vehicle (such as vehicle 12 of FIG. 7). A trailing, or service vehicle end 30 of power module 10 is shown with a pair of similar mounting brackets 36 and 38 configured to mate and de-mate from a mounting bracket assembly such as on a front-end loader service vehicle similar to mounting bracket assembly 46 of FIGS. 6 and 7.

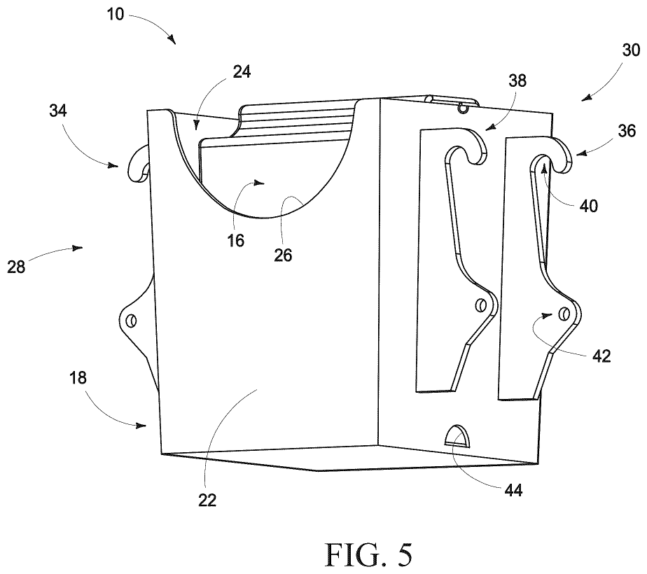

Kramer loader brackets 32, 34, 36 and 38 of FIGS. 4 and 5 each include a hook 40 provided along a top end and a pin bore 42 along a bottom end. Optionally, any of a number of equivalent complementary mating and de-mating connectors or brackets can be used for forward and rear mounting brackets, such as such as a Caterpillar CAT IT28 interface bracket and frame assembly. Other similar loader brackets can also be used on powder module 10 having any combination of pins, hooks, fixtures or fasteners that quickly and easily enable mating and de-mating between such components.

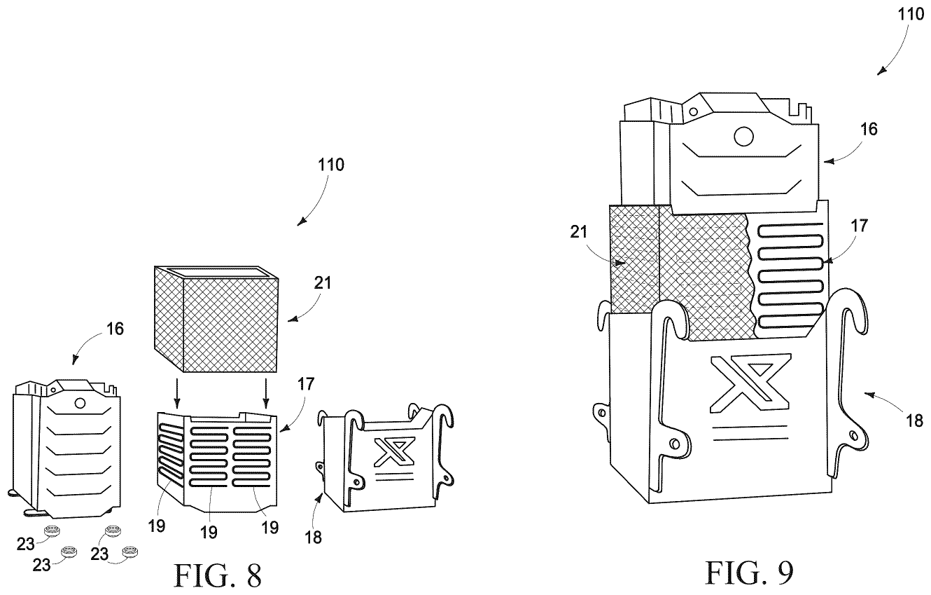

According to one construction, brackets 32,34, 36 and 38 and bucket, or box 22 are each formed from plate steel with brackets 32, 34 and 36, 38 being edge welded onto opposed outer surfaces of box 22 to provide forward bracket assembly 28 and rearward bracket assembly 30. A cavity, or recess 24 in box 22 of frame, or cage 18 is sized and shaped to encase, receive and support battery 16 internally therein. In an optional configuration depicted in FIGS. 8 and 9, a gap is provided between battery 16 and an inner surface of box 22 to fit a shock absorbing pad 21 and a battery heating pad 17 between battery 16 and box 22 of frame 18 to provide heating of such battery and shock or vibration protection. A recessed lip edge 26 is provided between each pair of support brackets 32, 34 and 36, 38 to facilitate visual identification of a loaded battery within box 22. Although shown as a box or cage, frame 18 can take on the form of a platform, an encasement, a bucket, a framework, a housing, or any other structural apparatus suitable for encasing, supporting, hanging, or housing a power supply, such as a vehicle battery.

FIG. 5 is a perspective view from above and in front showing a trailing, or lifting end of a power module 10 with a rearward bracket assembly 30 opposite a forward bracket assembly 28 that mates with a service vehicle that is used to remove and/or install the power module 10 from a vehicle being powered by the power module 10. A drainage aperture, or scupper 44 is formed in a bottom edge of box 22 configured to remove any water or moisture that otherwise enters box 22. Optionally or additionally, a cover can be provided atop box 22 to weatherproof or encase battery 16 therein.

FIG. 6 is a vertical front view of an electric vehicle power module mounting bracket assembly 46 that is provided on both a maintenance vehicle used to lift a power module 10 (see FIG. 7) at a rear end or on a receiving vehicle that uses the electric battery of the module 10 at a front end to power the receiving vehicle. More particularly, mounting bracket assembly 46 includes a top cylindrical frame tube 48 and a bottom cylindrical frame tube 50. Individual fixed cylindrical steel pins, or posts 52 and 54 extend from each end of tube 48 whereas extendible/retractable cylindrical steel pins, or posts 56 and 58 extend from each end of tube 50. Each pin 56 and 58 is coaxially received within an inner bore of tube 50 for reciprocation responsive to a double end fed hydraulic pump 60 and 62 that alternately feed hydraulic fluid to an internal piston (not shown) within tube 50 and affixed to each pin, or post 56 and 58 so as to move posts 56 and 58 inwardly and outwardly as is presently understood by those using bracket assemblies 46 which are presently used for mounting plows and buckets onto front end loaders.

FIG. 7 is a rear vertical view of an electric vehicle (EV), or electric front end loader 12 having the mounting bracket assembly 46 of FIG. 6 rigidly affixed to a frame of the vehicle 12. Mounting bracket assembly 46 is configured to receive and affix a power module 10 thereto using a service vehicle (not shown), such as another front end loader, to pick up a power module 10 on an opposed side from that being affixed to vehicle 12. Loader brackets 32 and 34 on frame 18 of battery module 16 are raised and manipulated into position by another front end loader (affixed to an opposed side of module 16) so as to engage hooks 40 with pins of top frame tube 48 while holes, or bores 42 are aligned with retracted pins, or posts of lower frame tube 50 after which pins on lower frame tube 50 are extended hydraulically by assemblies 60 and 62 to extend pins of tube 50 into bores 42 to lock power module 10 onto mounting bracket assembly 46 and frame of vehicle 12. Power module 10 is received into a complementary recess, or bay 20 in vehicle 12. Assembly 46 and brackets 32 and 34 together form a complementary mounting assembly, or quick coupling assembly 31 for removably mating and de-mating power module 10 from vehicle 12 to facilitate quick, easy and safe interchange of power modules as batteries need maintenance and replacement, or recharging.

According to one construction, vehicle 12 and battery 16 each have complementary mating electrical and/or control connections (or data buses) male and female adaptors that provide for quick exchange mounting between a vehicle and a battery.

FIG. 8 is an exploded, or disassembled perspective view from above and behind of an alternatively constructed power module 110 over that shown in FIGS. 1-7 and having additional shock mitigating and heat generating capabilities. More particularly, power module 110 includes battery module 16 which includes an array of four individual air shock mounts 23 affixed to a bottom surface. A heater liner, or blanket 17 encircles battery module 16 and has a series of individual circuitous elongate coated heater wires, such as a Nichrome wire encased in a covering of polytetrafluoethylene (PTFE) that encircle battery module 16 and are affixed onto a cloth or scrim carrier fabric for generating heat the warms up a battery module either during use and/or during charging. Optionally, any suitable heat generating elongate heater can be used including resistive wire heaters, resistive trace materials, or any other form of heater. In addition, a shock absorbing cover, or liner 21 encircles heater liner 17 to provide shock and vibration isolation to battery module 16 relative to cage, or frame 18 and a vehicle to which power module 10 is affixed.

FIG. 9 is an assembled view of the alternative power module 110 of FIG. 8. Battery module 16 is shown nested within heater liner 17 and shock absorbing liner 21 as they nest snuggly within cage, or frame 18. One exemplary form of shock mitigating mounts is a single tire Adjustable Air Spring, Single Tire, 3.8″ Extended Height Model No. 9539K41, available from McMaster-Carr (https://www.mcmaster.com), 9630 Norwalk Blvd. Santa Fe Springs, CA 90670-2932.

One exemplary form of heater pad 17 is a knit fabric sock that has circuitous PTFE coated Nichrome resistance heating wire sewn into positions about the knit fabric sock. Further details of such heating wire or elongate heater are provided in Applicant's issued U.S. Pat. No. 11,231,171B attached in Appendix A. However, any form of heating material can be utilitzed as presently understood by one of ordinary skill in the field including electrically resistive heating devices, mats, rope heaters, ceramic heaters or other suitable heaters.

One exemplary form of shock absorbing pad 21 is one of the following shock absorbing foams such as a Fabric-Reinforced Vibration-Damping Pad Packs for Heavy Machinery, black Nitrile rubber, Model No. 9030N11 sold by McMaster-Carr (https://www.mcmaster.com), 9630 Norwalk Blvd. Santa Fe Springs, CA 90670-2932. Optionally, any form of compressible foam, rubber, synthetic rubber, or expanded plastic can be used to construct panels of shock mitigating pads that encompass a battery pack. Another is use of an air bladder pad with/or without air vents and containing an inner foam encases in a sealed pad.

A method is provided for mating and de-mating a power support module from a battery powered vehicle having a complementary mating interface. Providing a forward mating interface on a power module encasement containing a battery, providing a rearward mating interface on the power module encasement. Mating the forward mating interface with a complementary mating interface on a battery powered vehicle while lifting the power support module and battery with the rear mating interface using another complementary mating interface on a service vehicle. Releasing the rearward mating interface after engaging the forward mating interface to mate the power module to the battery powered vehicle.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

In compliance with the statute, the various embodiments have been described in language more or less specific as to structural and methodical features. It is to be understood, however, that the various embodiments are not limited to the specific features shown and described, since the means herein disclosed comprise disclosures of putting the various embodiments into effect. The various embodiments are, therefore, claimed in any of its forms or modifications within the proper scope of the appended claims appropriately interpreted in accordance with the doctrine of equivalents.

What is claimed is:

1. A power module support case, comprising:
an encasement having a cavity configured to support a power module having a forward mounting bracket and a rearward mounting bracket of a quick coupling assembly configured to mate and de-mate the power module from both a service vehicle and a user vehicle.

2. The power module support case of claim 1, wherein the power module comprises a battery, and further comprising a shock mitigation device disposed between the encasement and the battery.

3. The power module support case of claim 1, wherein the power module comprises a battery, and further comprising a heater disposed between the encasement and the battery.

4. The power module support case of claim 3, wherein the heater comprises at least one elongate resistive heating element configured to traverse an expansive region on an inner surface of the encasement.

5. The power module support case of claim 3, wherein the heater comprises a heat generating mat provided between the encasement and the battery.

6. The power module support case of claim 5, further comprising a shock mitigation device disposed between the encasement and the heat generating mat encompassing the battery received in the encasement.

7. The power module support case of claim 6, wherein the shock mitigating device comprises an air spring mount.

8. The power module support case of claim 6, wherein the shock mitigating device comprises a shock mitigating pad.

9. The power module support case of claim 1, further comprising a shock mitigating device disposed between the vehicle and the power module comprising one or more of an air shock mount and a shock absorbing liner disposed between the encasement and the power module.

10. A power module support case, comprising:
a frame configured to support a power module having a first mounting bracket and a second mounting bracket spaced from the first mounting bracket each configured to be mated and de-mated with a quick coupling assembly provided on both a service vehicle and a user vehicle.

11. The power module support case of claim 10, wherein the first mounting bracket is affixed to one side of the frame and the second mounting bracket is affixed to an opposed another side of the frame.

12. The power module support case of claim 11, wherein the first mounting bracket and the second mounting bracket each comprise a pair of parallel, spaced-apart loader brackets each having a hook and a pin bore configured to receive a stationary pin and a retractable pin on one of a user vehicle interface and a service vehicle interface.

13. The power module support case of claim 12, wherein the one of the user vehicle interface and the service vehicle interface comprises a loader pin and bushing interface assembly configured to mate and de-mated with the pair of loader brackets.

14. The power module support case of claim 10, wherein the power module comprises a battery, and further comprising a heater disposed between the frame and the battery.

15. The power module support case of claim 10, further comprising a shock mitigation device disposed between the frame and the power module.

16. A method is provided for mating and de-mating a power module with a battery powered vehicle, comprising:
providing a vehicle having an interface for supporting a power module, a power module encasement for containing a source of power, a forward mating interface, and a rearward mating interface both complementary to the vehicle interface;
engaging the rearward mating interface on the power module using another complementary interface on a loading vehicle;
lifting the power module with the rearward mating interface;
one of engaging and disengaging the forward mating interface on the vehicle interface while lifting the power support module and the battery with the rear mating interface using the another complementary mating interface on the loading vehicle; and
releasing the rearward mating interface after one of engaging and disengaging the forward mating interface to mate the power module to the vehicle.

17. The method of claim 16, wherein the vehicle and the loading vehicle interface each comprises a pair of upper horizontal pins extending laterally outwardly and a pair of lower horizontal extendible/retractable pins and the forward and rearward interfaces of the power module each comprise a frame having a complementary pair of vertical loader brackets laterally spaced apart having an upper hook and a lower bore each configured to receive respectively the upper horizontal pins and the lower horizontal pins, and engage the upper horizontal pins within the upper hooks on one of the front interface and the rear interface.

18. The method of claim 17, further comprising extending outwardly the lower pins to lock the one of the vehicle and the loading vehicle interface with the one of the forward pair of loader brackets and the rearward pair of loader brackets.

19. The method of claim 16, wherein the power module comprises a battery and further comprising providing a heat generating mat within the encasement encompassing the battery received within the mat and the encasement, and generating heat with the mat to heat the battery.

20. The method of claim 16, further comprising providing a shock mitigation device disposed between the encasement and power module, and mitigating shock transmission from the vehicle to the power module.
